(19) United States
(12) Patent Application Publication
(10) Pub. No.: US 2005/0194065 A1
(43) Pub. Date: Sep. 8, 2005

(54) Basketmold, method and system for making a basketmold

(76) Inventor: Nathan Taylor, Warner, NH (US)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/771,999

(22) Filed: Feb. 4, 2004

(51) Int. Cl. B27J 1/00

(52) U.S. Cl. 147/48

(57) ABSTRACT

A basket mold and a method of making a basket mold for fabricating handwoven wooden baskets and, in particular, to a multi-part mold for shaping the basket. The multi-part mold is made up from a plurality of mold sections held together in a desired shape and orientation by a fastener. The multi-part mold may be in the form of a system for molding baskets of varying sizes specifically by adding additional mold sections to the multi-part mold, or subtracting mold sections from the multi-part mold in order to respectively increase or decrease the size of the mold, and hence the basket woven thereupon.

### FIELD OF THE INVENTION

The present invention relates generally to a basket mold and a method of making a basket mold for fabricating handwoven wooden baskets and, in particular, to a multi-part mold for shaping the basket. The multi-part mold is made up from a plurality of mold sections held together in a desired shape and orientation by a fastener. The multi-part mold may be in the form of a kit for molding baskets of varying sizes specifically by adding additional mold sections to the multi-part mold, or subtracting mold sections from the multi-part mold in order to respectively increase or decrease the size of the mold, and hence the basket woven thereupon.

### BACKGROUND OF THE INVENTION

There are numerous styles of handwoven baskets and such styles encompass baskets of many different shapes and sizes, for example, oval baskets or rectangular baskets as well as baskets that are anatomically contoured such as a fisherman's creel for adjusting to fit the hip or side anatomy of a fisherman. Almost all such styles of baskets, in particular, when handwoven, are woven upon a basket mold. The basket mold, as known in the art, is a solid, one-piece mold made generally of wood, plastic, Corian® or other suitable materials, and defining an outer surface shape around which the basket is woven with the purpose of attaining substantially the same shape as the outer surface of the mold.

Baskets can be made in any number of forms, some have both woven bottoms and sides, as well as a woven top, or lid. Other baskets have a wooden bottom, or base to which the woven sides of the basket are attached. Wooden tops or lids may also be utilized for all types of baskets. Molds for such different basket types vary in the manner in which the bases are affixed. For example, a basket mold for weaving a wooden bottom may have an indentation in the bottom for receiving and securing the wooden base, whereas a mold for a woven base need only provide a surface for supporting the base and securing pins which affix the woven base directly to the mold.

By way of example, a basket of the lightship basket-type, which originated in the nineteenth century on Nantucket Island and having unique aspects including a slotted, wooden base and being woven out of for example; reed, cane or wooden staves and reed, cane or wooden weavers. Lightship baskets also have a nailed wooden top rim as a specific characteristic, in any event, such baskets are just one example of a type of basket which is often handwoven upon a mold.

In order to better understand the basket mold and method of making a basket mold as described in the detailed description of the present invention, a general description of the known process of making a basket upon a conventional mold is first described.

A base, either woven or carved, cut or formed from solid wood, is affixed i.e. removably held in place during the weaving process, for example by pins or a screw, to a base portion of the basket mold. Staves are attached to the base and extend outwards and upwards from the basket base, along the basket mold walls to approximately the top edge of the mold. Perpendicularly through the staves are woven the cane weavers in parallel relationship to one another, and the cane weavers are worked in between the staves about the circumference of the mold.

The mold bottom and sides are sized and shaped to correspond to the desired shape of the basket interior. For example, a basket having a square base, outwardly inclined sides and a square top rim that is substantially larger than the base would be constructed using a mold having a square base and outwardly inclined side walls whose upper ends are substantially larger than their lower ends. Similarly, a basket having a rectangular base, relatively straight side walls and a rectangular top rim that is only slightly larger than the base would be constructed using a mold having a rectangular base and relatively straight side walls whose upper ends are only slightly larger than their lower ends.

The mold also has a top surface or portion connected to the upper ends of the side walls. The shape of the top does not affect the shape of an open-top basket. The top of the mold may include a spindle-receiving recess that extends into the body of the mold to allow the mold to be supported on a spindle during weaving. The spindle may be connected to a weaving stand, or “horse”, to facilitate rotation of the mold and the partially constructed basket during the weaving step. Advantageously, the weaving stand can support the mold in a variety of positions between a generally upright position and a generally horizontal position to allow the weaver to vary the position of the mold.

An inner top band, which defines the top edge or rim of the basket, is wrapped around the mold along the upper edges of the side walls. The inner band may be secured in this position by clips attached to the mold, by a fastener inserted through overlapping portions of the band or both.

The bottom panel or basket base is attached to the bottom of the basket mold, with the center of the woven panel or wooden base overlaying and aligned with the bottom of the mold. The bottom panel is clamped to the mold to prevent the panel from shifting relative to the mold when the mold is manipulated during weaving of the side panels. The weaving staves which are attached to the bottom panel or wooden base are bent around the mold to conform substantially to the side walls of the mold, with the ends of the staves near the top edge of the mold sides.

The side panels of the basket are constructed by cane weaver strips through the splint ends, usually beginning adjacent the bottom panel or wooden base and working upwards along the sides of the mold toward the ends of the weaving splints. The cane weaver strips are drawn tight against the mold such that the weaving staves remain in close conformance to the side walls of the mold. When the cane weavers have reached the desired height, usually adjacent the top edge and surface of the mold, the ends of the weaving staves are trimmed as close as possible to the upper edge of the inner band. An outer top band may be wrapped over the stave ends in substantially overlaying relationship to the inner top band. The splint ends are secured to the bands by fasteners or the like, and the completed basket is lifted from the mold. Preferably, both inner and outer top bands are used to create finished appearance and provide a stronger basket. However, it also may be possible to construct a useful basket with only a single top band.

Molds, however are expensive to make. They must be carved or formed from one piece of material, or smaller pieces of material are cut or formed and then glued up, to make the mold. The glueing up process is difficult for the main reason that the smaller pieces must be held in close alignment when being glued up, and it is difficult to maintain the tolerances necessary for producing a quality mold. Furthermore, once made the known molds are not readily disposed to be made larger or smaller to permit the making of different size baskets. In fact, it is well known in the art, for each different size of basket to be made, an entirely different mold must be used, even where the same shape is generally desired.

### OBJECT AND SUMMARY OF THE INVENTION

Wherefore, it is an object of the present invention to overcome the above mentioned shortcomings and drawbacks associated with the prior art.

Another object of the present invention is to facilitate the process of making a basket mold for a hand woven basket by providing a multi-part mold comprising a plurality of separate mold pieces which can be held together by a fastener.

A further object of the present invention is to provide the multi-part mold with a fastener which facilitates the alignment within a necessary tolerance of the plurality of separate mold pieces into the desired mold shape for making a basket.

Yet another object of the present invention is to permit the addition of additional separate pieces to the mold to make a larger mold and hence a larger basket and also allow the subtraction of certain pieces from the mold to make a smaller mold.

A still further object of the present invention is to produce a kit for making a mold which contains a plurality of individual mold pieces and a fastener for securing the mold pieces together for either a glue-up operation or to facilitate the addition and subtraction of certain mold pieces respectively to and from the mold.

The present invention also relates to an expandable mold for making a basket comprising a plurality of separate mold sections comprising at least a bottom section and a top section defining a sidewall extending therebetween, wherein the plurality of separate mold sections are secured together to form the mold by a releasable fastening mechanism.

The present invention also relates to a system for making a basket mold including a plurality of structural components for construction of the basket mold, the structural components comprising a top mold section and a bottom mold section including, a body defined by a planar top surface, a planar bottom surface and a sidewall extending therebetween, each body including a substantially similar cross-section to which a basket component formed on the basket mold is to attain, at least a passage extending between the top surface and the bottom surface of the body, a fastening element for insertion through the passage to secure the top and bottom sections together.

### BRIEF DESCRIPTION OF THE DRAWINGS

The invention will now be described, by way of example, with reference to the accompanying drawings in which:

FIG. 1 is a perspective top view of a basket mold as known in the art;

FIG. 2 is a bottom perspective view of a basket mold as known in the art;

FIG. 3 is a perspective top view of the present basket mold;

FIG. 4 is a bottom perspective view of the present basket mold;

FIG. 5 is a planar cross-sectional exploded view of the present basket mold and fastening device;

FIG. 6 is an planar view of the basket mold sections;

FIGS. 7a, b are a bottom and cross-sectional side view of a basket lid mold.

FIG. 8 is a planar end view of a round rim mold and mount device;

FIG. 9 is a planar front view of the round rim mold and mount device;

FIG. 10 is a top view of a flat style rim mold;

FIG. 11 is a planar side view of the flat style rim mold; and

FIGS. 12a, b are an exploded planar view and a top view respectively of a basket handle mold.

### DETAILED DESCRIPTION OF THE INVENTION

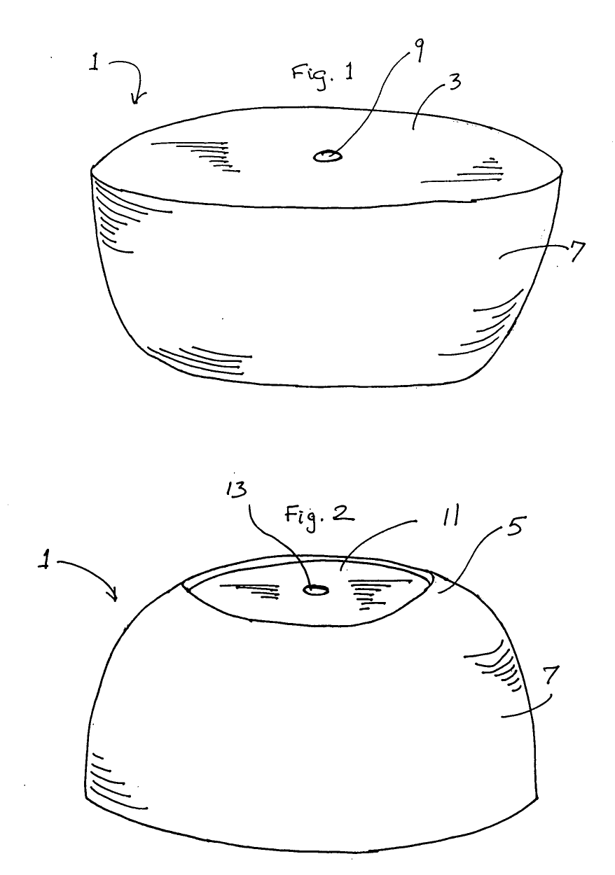

Observing FIGS. 1 and 2, a brief description concerning the various components of basket molds will now be briefly discussed. As can be seen in this embodiment, FIG. 1 shows a basket body mold 1 as is well known in the art, which is generally a one-piece, solid mold having a top portion 3, a base portion 5 and a side wall 7extending therebetween. The top portion 3 is often provided with a spindle hole 9 for receiving a spindle mounted to a support, or horse (not shown) on a work table. The spindle, not shown, has one end generally oriented in a direction towards the basket maker and another end attached to the table in such a manner so as to directly support the basket mold 1 via the spindle hole 9 in an orientation with the base of the mold facing towards the basket maker to facilitate the weaving of the basket on the mold.

FIG. 2 shows the bottom portion 5 of the mold having a recess 11 formed therein for receiving and retaining a basket base or plate which forms the bottom of the basket itself, and to which the basket side weaving staves are attached. It is not always necessary to have such a recess 11, but is sometimes necessary with the incorporation of a wooden base into the basket. Alternatively, a plated base, i.e. a woven basket base, is generally secured to the base of a mold by pins or nails without such a recess. In this case, because most molds are made of hardwood or other dense material, it may be necessary to have a soft wood base portion 5, or even a soft wood insert in the recess of the base to accept such pins or nails. Although it is also conceivable that in certain cases either a wooden base or a woven plate may be affixed to a mold 1 either having, or not having, such an indentation or recess 11. However, for purposes of explanation in both the drawings and the description, the main embodiments of the present invention will be described in conjunction with a method for forming a basket having a wooden base and thus will include the base receiving recess 11.

In the center of the base recess, a base receiver 13 is generally positioned for receiving a screw or bolt or other fastener for securing the basket base to the mold. The wooden basket base has a hole drilled through the center and is removably attached to the bottom of the mold in the base recess by inserting a screw or bolt through the hole in the wooden base and into the base receiver in the mold. Once the basket is complete, the base receiver permits the relatively simple removal of the mold from the completed basket by unfastening the screw or bolt from the base receiver.

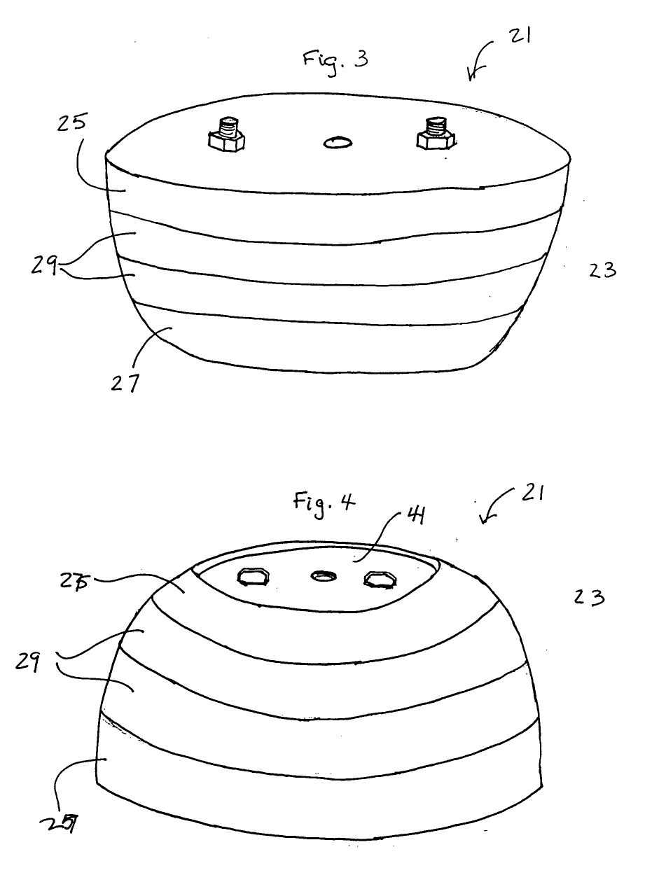

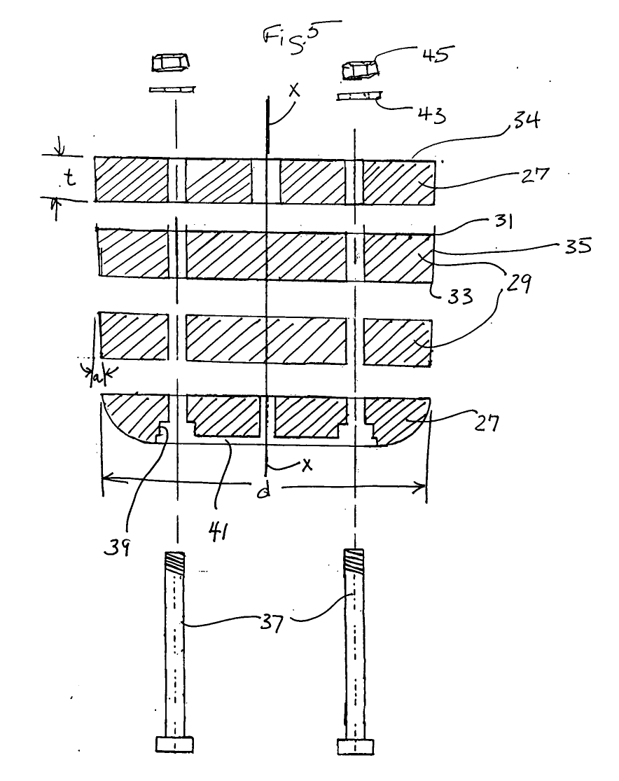

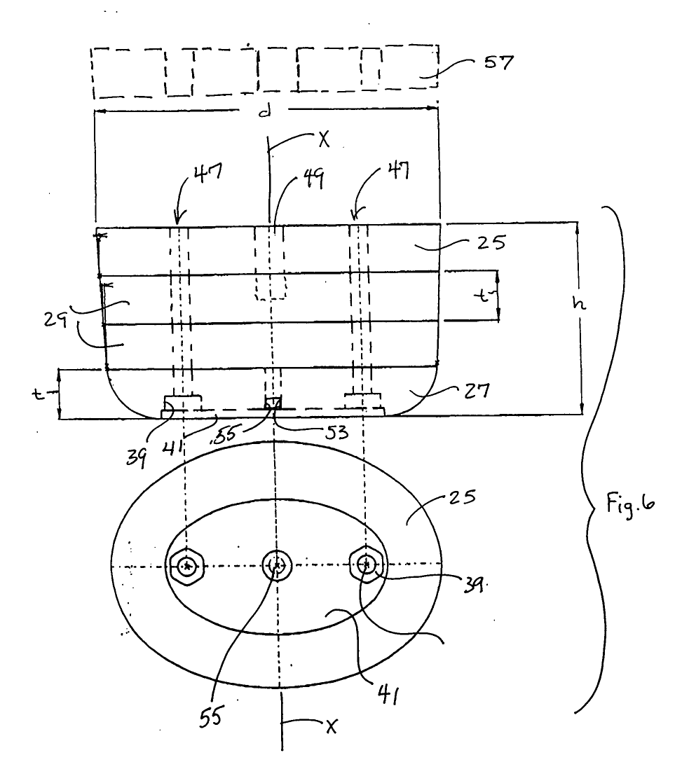

Turning to FIGS. 3 and 4, a perspective top and bottom view of the mold of the present invention is now described. Instead of being a solid piece, the novel mold 21 is composed of a plurality of separate sections 23 or layers specifically including a top section 25, a bottom section 27 and, if necessary, a plurality of intermediate sections 29 therebetween. The sections 23 are essentially planar and stacked parallel and adjacent one another in a specific order ensuring that generally the section having the smallest radius is the bottom section 27 of the mold. Each successive section from the bottom section 27 is generally slightly larger in radius than the previous section, i.e. the bottom edge 33 of a successive section matches the top edge 31 of the immediately preceding section 23. The sections 23 may be of the same thickness t, or may also be of different thicknesses.

Additionally, as seen in FIG. 5, each mold section 23 has a top surface defining a top edge 31 and, except for generally the bottom section 27 which has a smooth bottom transition, a bottom surface defining a bottom edge 33. The top and bottom edges 31, 33 in turn define a mold sidewall portion 35 therebetween. Because of the generally flaring nature of baskets walls, the top edge 31 of each section is also generally larger in diameter d than the bottom edge 33. This means that the sidewall portion 35 of each mold section 23 is formed at an angle a relative to a central vertical axis x of the basket mold, although the sidewall portion could be vertical as well.

Each sidewall portion 35 of the sections 23 of an individual mold have substantially the same angle relative to the vertical axis x. This ensures a smooth transition between the top edge of each section 23 and the bottom edge of the following section 23 and provides for a contiguous and consistent mold outer surface as defined by the plurality of the sidewall portions 35 of the stacked sections 23. Once stacked in the appropriate order, i.e. with successively larger sections subsequent to each preceding section 23, the sections 23 are secured together by a securing device, for example two bolts 37 which extend from a countersunk portion 39 of the base recess 41, internally through each section of the mold, and out through the top section 25 of the mold. The mold sections 23 are then secured by a washer 43 and a nut 45 applied to each of the bolts 37, the nuts 45 being tightened down against the top surface 34 of the top mold section 25 to sandwich the separate sections 23 together.

It is to be appreciated that any number of bolts 37 may be necessary to adequately secure the sections 23 of the mold together. For instance, assuming a substantially round or oval mold in the range of 2 to 4 inches in diameter, only 2 bolts 39 may be necessary, for a larger mold in the range of 5 to 24 inches or more in diameter, 3 or 4 or even more bolts may be necessary to adequately secure the sections together. Additionally, other fastening devices for example straps or internal pins may also be used to secure the separate sections together.

Turning to FIG. 6 the sections 23 or layers of the mold 21 can thus be secured together by the fastening device, i.e. in the presently described example, the nuts 45 and bolts 37. To align the bolts 37 through the mold, the sections of the mold define two throughbores 47 through which the bolts 37 extend from the bottom section 27 of the mold to the top section 25 of the mold. It is to be appreciated, as will be discussed in further detail below, that by providing bolts of longer lengths, or shorter bolts, additional sections, generally further top sections 25, may be respectively added or subtracted from the mold to make the mold larger or smaller depending on the basket makers desire.

The individual mold sections 23 can be made from any material, but for most purposes may be cut from stock plywood of any type, pine, birch, oak or other soft or hardwoods, or other such readily available and economical wood stock. Using conventional wood stock permits conventional cutting tools to be used to efficiently cut each section of the mold. Thus, most mold sections 23 will range in thickness t from less then an inch, to several inches, and more preferably about 0.25 inch to 1.0 inches. The cross-grain of such plywoods also assists in maintaining the stability of the mold when it is finally clamped together by the bolts or glued-up.

The top section 25 of the mold, as discussed with respect to the prior art, besides having the throughbores for the bolts, is provided with the spindle hole 49 substantially located in the center of the top section 25 along the center vertical axis x of the mold. This spindle hole 49 may, in fact, extend part way through, or all the way through the top section 25 and can even continue to extend into one or more of the intermediate sections 29 dependent upon the support necessary and, more particularly, on the size of the mold.

The bottom section 27 of the mold is provided with countersunk bolt head holes 39 for each of the necessary bolts in the recess 41 to permit the bolt heads to be drawn into the countersunk bolt head holes 39 when the nuts 45 are tightened on the opposing ends of the bolts 37. Thus, the bolt heads are positioned below the recess 41 in the bottom section 27 so that the bolt heads do not interfere with either a woven or wooden base affixed to the bottom section 27 of the mold. An additional recess, hole or cavity 53 is provided in the center of the bottom section 27 of the mold along the center axis x of the mold to form or hold the base receiver 55. The base receiver 55 may be a threaded nut which is glued or fastened in the additional recess or hole 53 to thus accept a bolt or screw for securing the basket base to the bottom section as described above.

With the sections 23 stacked in their appropriate alignment as shown in FIG. 6 it is readily apparent that given a fastener such as the described bolts 37 which are sufficiently long enough to extend through all the sections 23, an additional section, or even a plurality of additional sections could be added to the mold. In the example shown, a section 57 shown in dashed lines may be added to the stack of mold sections to extend the height h, as well as diameter d of the top portion of the basket mold. This is an important aspect of the present invention because it permits the basket maker to utilize a single basket mold to make a variety of differently sized baskets without having to buy or fabricate an entirely new mold.

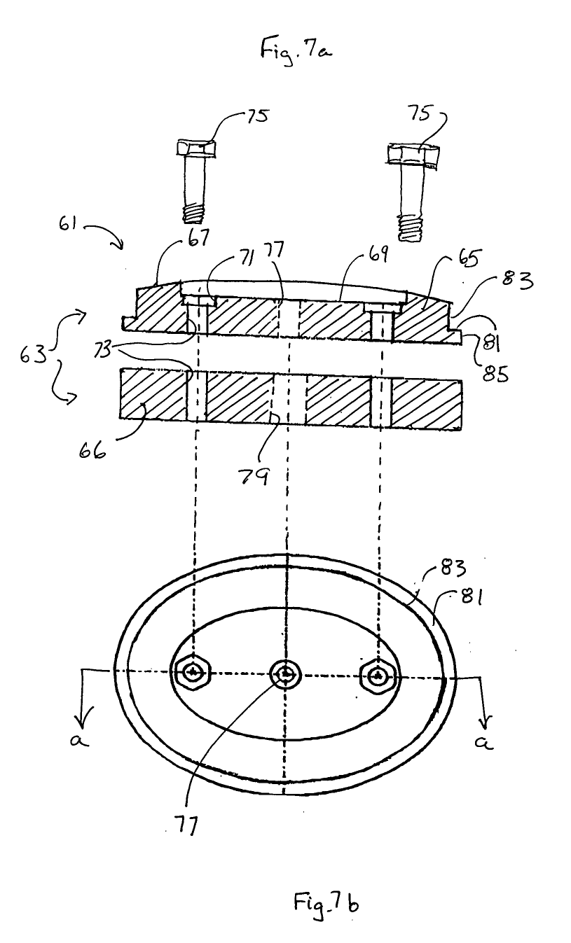

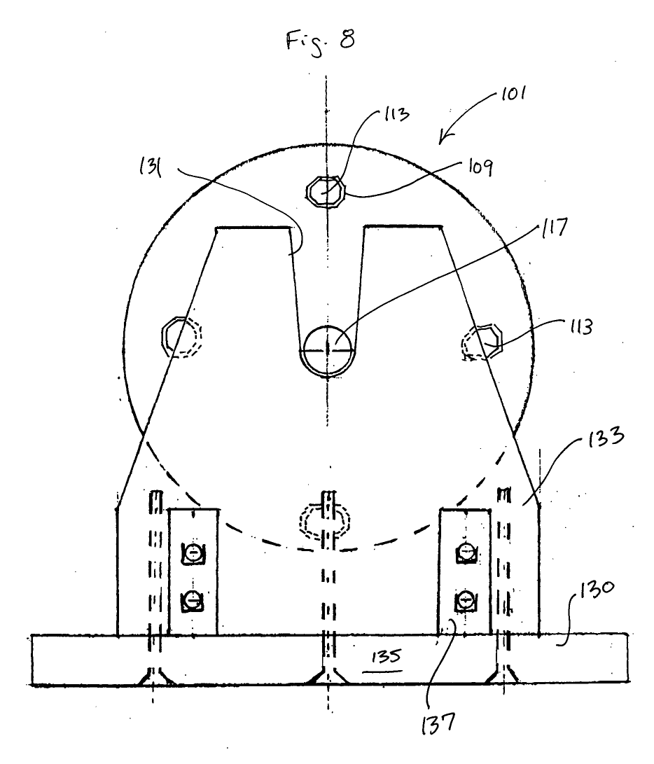

Observing a lid mold 61 as shown in FIG. 7a further embodiment of the present invention will now be described. Woven baskets may also be provided with a woven lid which, like a basket body, generally requires the lid mold 61 as seen in FIG. 8. The lid mold 61, although generally substantially shallower in nature, i.e., not as tall or deep as the basket body itself, is thus also best woven on a lid mold 61. The lid mold 61 may also be constructed of a plurality of sections 63 as described in the above discussed basket body mold. The exemplary lid mold is shown, in a manner somewhat reverse from the basket body mold, having a top section 65 comprising a top surface 67 which can either be provided with, or without a recess 69 for securing a wooden top or a woven top, and counter sunk bolt head holes 71 in the recess 69 communicating with the bolt throughbores 73.

The top section 65, bottom section 66 and any intermediate sections of the lid mold also include the throughbores 73 for permitting the passage of a securing device, namely bolts 75 as similarly described above. At least the top section 65 of the lid mold 61 may also be provided with an anchor or receiver 77 usually at the central axis x of the lid mold for receiving a screw or bolt for holding a wooden top attached to the lid mold 61. To facilitate the lid weaving process, a support hole 79 may be formed at least through a portion of the bottom section 66 to receive the spindle of the mold support or horse as it is mounted to the basketweaver's bench or table. The top section 65 of the lid mold 61 is further provided with a lip 81 or ledge extending circumferentially about the top portion and which is substantially the same diameter as the adjacent mold section as shown and defines a circumferential indentation 83 extending completely around the top section. The indentation 83 is designed to accept an inner rim of the basket lid prior to weaving the basket lid, and the inner rim essentially fills out the indentation 83 so that an outer surface of the inner rim substantially matches the outer contour of the top section sidewall surface 85.

It is also to be appreciated that, like the basket mold 21, the lid mold 61 may be made larger or smaller by adding or subtracting sections 63 to the lid mold with an appropriate length bolts 75 being supplied. Although in general, a lid mold 61 is comprised of substantially fewer number of sections 63 than the relative body mold.

The rims that are utilized to finish the edges of a basket, and which essentially define the topmost edge of a basket, or the lower edge of a lid, are generally made from precurved wood or reed material and are bent by a heating and water application process prior to being molded, cut and attached to the top rim of a basket. The present method of making a mold is also more than capable of being utilized to fabricate a rim mold as discussed below for forming a substantial length of rim.

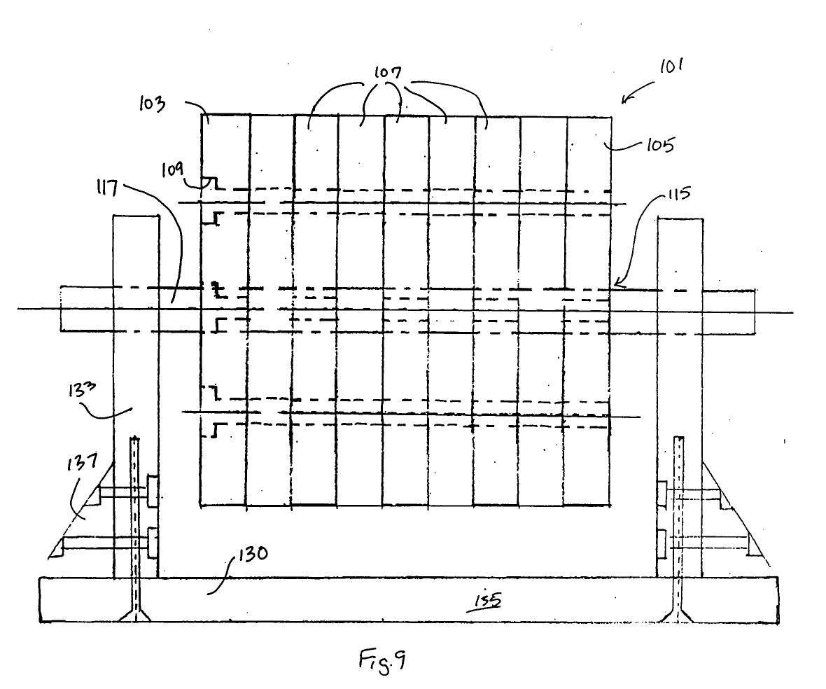

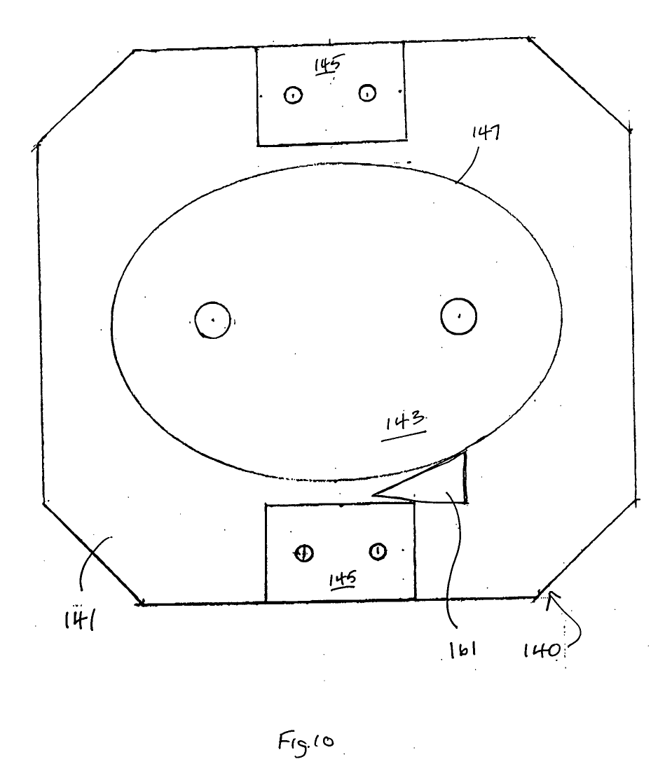

In another embodiment of the present invention shown in FIGS. 8 and 9, a round rim mold 101 is provided also comprising a plurality of mold sections including first and second end sections 103, 105 and a plurality of intermediate sections 107. The first end section 103 is provided with at least two, and preferably four countersunk holes 109 leading to respective throughbores 111 through the first end section 103 and all the other mold sections as well. Through each of the sections a bolt 113 is inserted in each throughbore 111 and a nut and washer on the opposing end draws the bolt head into the countersunk holes 109 to sandwich the intermediate sections 107 between the first and second end sections 103, 105 and hold them together in a particular desired alignment.

Different from the basket mold, each section of the round rim mold 101 has essentially the same diameter d, this is so a long length of rim stock or rim material for a number of rims, can be bent and formed on the rim mold 101 all at once. After the rim forming process is complete, the length of rim stock or rim material will be cut into smaller pieces to form individual rims.

In addition to the throughbores 109, the round rim mold 101 is provided with a center axis bore 115 through the center of the mold and through each mold section. This axis bore 115 accepts a spindle 117 for supporting the round rim mold 101 on a mounting platform 130 which will be described in further detail below. The spindle 117 passes completely through each section of the mold 101 and is supported at either end by the mounting platform 130 in a substantially horizontal manner with respect to a bench or table top supporting the mounting platform. Thus, for purposes of forming a round rim for a basket, each mold section 103, 105, 107 is horizontally adjacent its neighbor section and is snugly secured, usually by friction fit or even an adhesive element, glue or other securing means, to the spindle 117 to the extent that when the spindle rotates, the round rim mold 101 will rotate in conjunction therewith. On the other hand, the sections 103, 105 and 107 are not so tightly fit that a further mold section could not be added to the round rim mold 101, or a section removed from the spindle 117 manually by a basketmaker to make the basket larger or smaller.

With the spindle 117 inserted through the round rim mold 101, the ends of the spindle 117 are supported in the support slots 131 as shown in FIG. 9 formed in the sides 133 of the mounting platform 130. The sides 133 extend vertically from the base 135 of the mounting platform 130 which generally rests upon a table or bench. The sides 133 thus extend perpendicularly with respect to the base 135 and can be secured thereto by screws or bolts as known in the art. The sides 133 may also be provided with adjacent additional supporting members 137 to ensure that the sides 133 remain in a substantially perpendicular position with respect to the base 135. The support slots 131 have a slightly larger opening than a bottom portion to facilitate the entrance, exit and support of the spindle 117 therein.

For purposes of forming the rim, each end of the spindle 117 rests on the respective bottom portion of the slots 131 and thus the round rim mold 101 may be turned by an attached crank or even directly manually by other means such as known in the art to turn the round rim mold 101 when desired. By way of explanation, the use of the round rim mold 101 is as follows: a length of rim stock having a first and second end, which can be reed or wood for example, of a desired length and having been moistened with water and heated to a desired amount, is attached at the first end to the sidewall of the rim mold 101 by a pin, nail, staple or other such device wound circumferentially and horizontally around the round rim mold 101 by rotating the mold in the mount 130. The rim is formed about the mold in a spiral fashion by rotating the round rim mold in the mount 130 and allowing the rim stock to be drawn onto the mold in the spiral fashion so that it will dry thereon and be able to maintain the curved form once taken off the mold.

As the round rim mold 101 is rotated, the rim stock is applied to the rim mold and circumferentially and horizontally wound around in a spiral manner until the second end of the rim stock comes into proximity of the rim mold sidewall and is fastened to the mold with a pin or nail as described above. It is to be appreciated that the round rim mold 101 may be expanded by adding further sections, or reduced in length by removing sections by the same process as described with respect to the previously described embodiments of the invention so as to provide a variable size mold apparatus for forming shorter or longer lengths of rim material as desired.

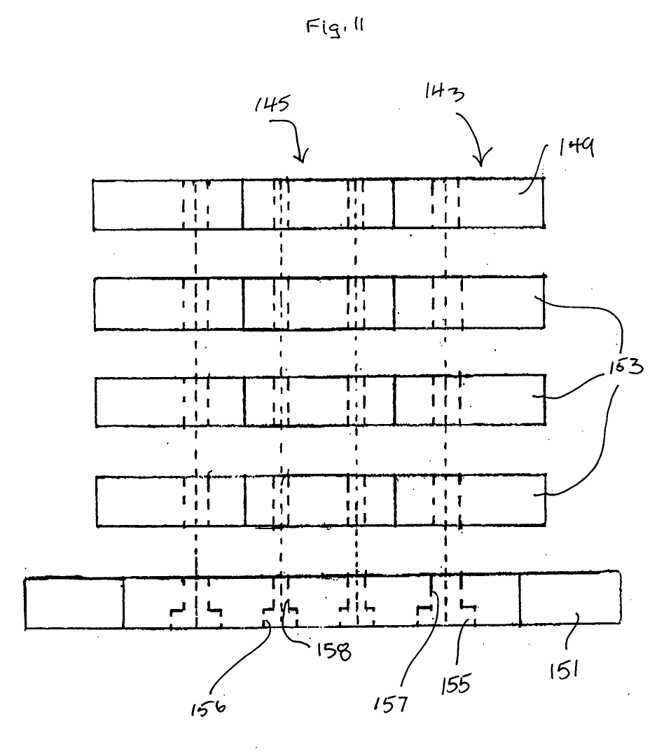

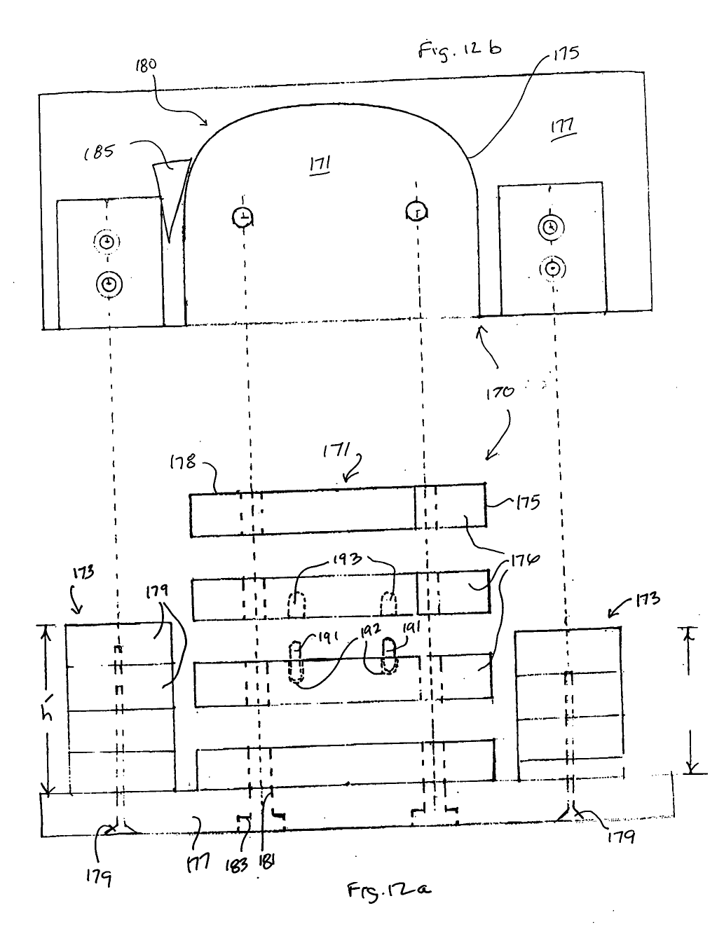

A flat style rim mold 140 as shown in FIGS. 10 and 11 has a flat base 141 which rests on a table and supports a round, oval or even a substantially rectangular or square central rim mold 143 in a vertically stacked manner as opposed to the horizontal alignment of the round rim mold sections. On either side of the flat rim mold 140, and also supported on the base 141, are biasing side blocks 145 oppositely aligned from one another and spaced relatively close to the sidewall 147 of the central rim mold 143. The biasing side blocks 145 assist in maintaining the rim stock on the central rim mold 143 once applied thereto.

The center rim mold 143 which essentially also incorporates the base 141 of the flat rim mold 140 can be provided, as with the basket body mold, made of a plurality of separate sections having a top section 149 and a bottom section 151 with a plurality of intermediate sections 153 positioned therebetween. Just as in the basket body mold, the base 151 of the flat rim mold 150 is provided on one side with countersunk bolt head holes 155 leading to the throughbores 157 or passages for bolts to secure both the central rim mold 143 and the biasing side blocks 153.

It is to be appreciated that the stackable sectional nature of the center rim mold 143 again permits the addition and removal of a more or less sections, by the use of longer or shorter bolts respectively, to the center rim mold 143 which would permit either more or less rim stock to be formed about the center rim mold 143. The same holds true for the side blocks 145 which if also made from a plurality of sections could be shortened or lengthened in conjunction with the central rim mold. Bolts extending from the countersunk bore head hole 155 in the base would pass through respective through bores 157 in the central rim mold as well as countersink holes 156 and throughbores 158 of the side blocks to secure all the individual sections to the base. The rim molds, whether the flat style or round rim mold, may be made in any diameter or shape essentially, for the desired size of the basket, but are generally between about 1 and 24 inches in diameter, and more preferably about 2 to 18 inches in diameter. Also the rim molds may have cross-sections which can be round, oval or even other shapes like slightly rectangular to conform to specific baskets.

By way of example, with an assembled flat style rim mold 140 as discussed above, once a desired height of both the center rim mold and the biasing side blocks is attained, the basket weaver takes a length of wet, heated rim stock and wraps it in a spiral type manner, like a spring, upwards from the base and around the center rim mold. At each level or pass of the rim material between the biasing side blocks 145 and the rim mold, it can be necessary to insert a wedge or a further biasing member 161 between the side block 145 and the rim material on the center rim mold 143. This ensures that the rim stock is maintained in a close and substantially conforming relationship to the center rim mold 143. The rim material is wound upwards towards the top of the central rim mold 143 to the extent desired or to a point where the center rim mold 143 can no longer support any further material.

Again, it is to be appreciated that any length of rim material could be wound depending on the expandability of the mold height by adding further sections to the central rim mold 143 to increase its height.

A handle mold 170 as shown in FIGS. 12a and 12b comprises a main center portion 171 and two side blocks. The two side blocks 173 are positioned oppositely and on either side of the central rim mold 171 but adjacent to the side walls 175 thereof so as to maintain the handle sections to be formed on the center handle mold 171. The center handle mold 171 comprises a base portion 177 which supports the center handle mold 171 and the two side blocks 173. Similarly to the above described embodiments, the center handle mold 171 comprises at least one, and more than likely a plurality of vertically stacked sections 179 relative to the bench or work table on which the base 177 is placed. The side blocks 173 generally rise to the same height h, or slightly lower, as the center handle mold 171 and are also comprised of a plurality of sections which can be lengthened or shortened as previously discussed in the embodiments above. The center handle mold 171 can be secured by a securing device, for example, one or two bolts extending in throughbores 181 defined by each mold section 176 from the base to the top section of the central handle mold 171. Both bolts can extend from a countersunk portion 183 in the base through and past the top surface 178 of the top section of the center mold 171 in order to permit a nut and washer to be placed thereon and tighten the stacked sections 176 similarly as discussed above with the previous embodiments.

The side blocks 173 may be secured by a long screw 179 or a bolt or pair of bolts as shown in a similar manner so that the side blocks can be made higher or lower in height in conjunction with additional or fewer sections added or subtracted respectively to the center handle mold 171. Any number of side blocks may be used around the center handle mold, for example another side block (not shown) may be placed at the top of the arch of the center mold 171. One of the end side blocks 173 is also generally provided with a greater height h′ than the remaining side blocks, but the same height as the center handle mold 171, to facilitate the wrapping of the handle material about the center handle mold 171 when the handle material is applied to the mold.

Unlike the rim molds, the individual handle stock for a basket handle are cut to a desired length and placed one at a time in a substantially vertically stacked manner with a first end of the handle stock being biased between the first side block and the center mold, the stock wrapped around the arch portion 180 of the center mold 171 and the second end being biased against the center handle mold 171 by the opposing side block 173. At least one wedge 185 may be inserted between the side blocks 173 and the handle material wrapped around the center handle mold 171 in order to more fully conform the handle to the center handle mold 171.

It should be appreciated that the number of sections in all the above described embodiments need to have their respective side wall portions substantially aligned with respect to each adjacent sections whether stacked vertically or horizontally, so that there is substantially no seam or differentiation or discontinuity in the side wall in the completed mold. Thus, besides the bolts and throughbores which assist in aligning the individual sections of all of the above embodiments of the basket mold, certain devices such as pins 191 and pin holes 192 as shown in FIG. 12a may be provided in certain sections and in certain alignments in order to ensure that the next adjacent section is properly aligned with its neighbor. The pins 191 can be removable, loosely fit or even permanently affixed within a section and the opposing holes 193 for receiving the pins in adjacent sections may be formed by in any manner as is well known in the art.

The present invention also lends itself to use with puzzle molds (not shown) which are utilized for making baskets which have smaller neck portions or rim diameters than the lower portion of the basket. Obviously, a one piece mold cannot be used to make such a basket as the larger portion of the mold would not be able to be withdrawn through the smaller neck or rim of the basket. A puzzle mold is generally made of separable opposing side portions, often times half-moon shaped and essentially mirror images of one another, and a center wedge portion. When the basket maker is done weaving the basket, the center wedge portion is withdrawn from between the side portions of the mold through the rim of the basket and then the opposing side portions can be sequentially withdrawn from the basket as well.

The side portions and center wedge portion of a puzzle mold can be made by the same method and system and described above. At least each side portion can be made of a plurality of mold sections and held together by a fastening device or bolts as described above. Whether the center wedge portion needs to be a single solid piece or can also be made from a plurality of mold sections may depend on the practicality of manufacture and use.

It is also to be appreciated that the above described molds, method of making the molds and mold making system can also be used to provide a pragmatic and inexpensive method of making a glued-up, solid, one piece mold. It is known that even a conventional one piece mold may be made of separate pieces of material. For example, a mold maker may glue large blocks of wood together and then carve or shape the mold into a desired shape. This process of gluing up the molds using many clamps and aligning the wood blocks, not to mention the shaping of the mold is expensive and time consuming. The present method and system allows for a more convenient and inexpensive mold fabrication, whether the mold is held solely by the fastening device during use, or if the fastening device is used merely as a clamp to align and permit an accurate glue up of the mold.

In a glue-up process utilizing the mold making system of the present invention, the mold maker can take the separate sections of the mold, align them, insert the fastening device, i.e. the bolts extending through the through bore defined by the aligned mold sections, and glue each of the mold sections to the. next adjacent section. The bolts are tightened to squeeze each of the mold sections together and with the sidewall portions of each mold section aligned to form a contiguous outer mold surface, the glue is allowed to dry. Thus the basket maker now has a solid glued-up one piece mold as is generally known in the art and the bolts may be either removed or left in the mold for the basket making process.

The above described basket mold making device and process permits accurate, inexpensive mold kits or systems containing the mold sections and fastening device to be readily produced by a manufacturer. Furthermore, because the manufacturer does not have to glue-up and finish each mold, the molds are less expensive. The basket maker or purchaser can then easily assemble and finish a mold by glue-up or by securing the planar mold sections together with merely the supplied bolts or other fastening device. The embodiments of the present invention may then also be expanded by adding or removing mold sections to make a different size basket, although it is to be appreciated that it would generally not be feasible to remove mold sections from a glued-up mold.

Since certain changes may be made in the above described basket mold and system for making a basket mold, without departing from the spirit and scope of the invention herein involved, it is intended that all of the subject matter of the above description or shown in the accompanying drawings shall be interpreted merely as examples illustrating the inventive concept herein and shall not be construed as limiting the invention.

1. An expandable mold for making a basket comprising:
a plurality of separate mold sections comprising at least a bottom section and a top section defining a sidewall extending therebetween; and
wherein the plurality of separate mold sections are secured together to form the mold by a releasable fastening mechanism.

2. The expandable mold as set forth in claim 1 wherein each of the plurality of separate mold sections has a passage defining a throughbore through the mold and the fastening mechanism comprises at least a bolt passing through the plurality of mold sections to align and fasten the plurality of mold sections together.

3. The expandable mold as set forth in claim 2 further comprising at least an intermediate mold section sandwiched between the bottom section and the top section.

4. The expandable mold as set forth in claim 1 wherein a first mold is defined by the releasable fastening mechanism securing at least the bottom section and the top section together, and wherein a second expanded mold is defined by release of the fastening mechanism and the addition of at least another separate mold section to the first mold, and the re-securing of the fastening mechanism to form the second expanded mold.

5. The expandable mold as set forth in claim 4 wherein each mold section comprises a substantially planar top and bottom surface defining a portion of the sidewall therebetween.

6. The expandable mold as set forth in claim 5 wherein the top surface of each of the plurality of mold sections has a top edge profile substantially matching a lower edge profile of the next adjacent mold section.

7. The expandable mold as set forth in claim 6 wherein the top surface of each of the plurality of mold sections is aligned with the bottom edge of the next adjacent mold section and the sidewall portions of each of the plurality of mold sections of each of the adjacent mold sections together define the contiguous mold sidewall.

8. The expandable mold as set forth in claim 7 wherein each of the plurality of mold sections comprises at least a passage, which when axially aligned with the passage of an adjacent mold section defines a throughbore in the basket mold for receiving a bolt for securing the mold sections together.

9. The expandable mold as set forth in claim 8 wherein part of the passage in the bottom mold section is provided with a larger diameter defining a countersunk portion into which a head of the bolt may be situated when a nut attached to the bolt at an end opposite to the head is tightened.

10. A method of forming a basket mold comprising the steps of:
forming a plurality of separate mold sections comprising at least a bottom section and a top section defining a sidewall extending therebetween; and
securing the plurality of separate mold sections together to form the basket mold by a releasable fastening mechanism.

11. The method of forming a basket mold as set forth in claim 10 further comprising the steps of fabricating each of the plurality of separate mold sections having a substantially planar top surface and bottom surface defining a respective top edge and bottom edge and forming the basket mold by starting from the bottom mold section and aligning the bottom edge of each successive mold section against the top edge of the previous mold section.

12. A system for making a basket mold including a plurality of structural components for construction of the basket mold, the structural components comprising:
a top mold section and a bottom mold section including;
a body defined by a planar top surface, a planar bottom surface and
a sidewall extending therebetween, each body including
a substantially similar cross-section to which a basket component formed on the basket mold is to attain;
at least a passage extending between the top surface and the bottom surface of the body;
a fastening element for insertion through the passage to secure the top and bottom sections together.

13. The system for making a basket mold as set forth in claim 12 wherein one of the top and bottom sections includes an edge defining a circumferential lower lip portion which in turn defines a circumferential indentation in the respective sidewall of the body for receiving rim stock material.

14. The system for making a basket mold as set forth in claim 12 wherein the respective top and bottom surfaces of both the top and bottom sections are provided with the same area and cross-section.

15. The system for making a basket mold as set forth in claim 14 further comprising a first and a second side blocks spaced at a fixed distance but adjacent the sidewalls of the top and bottom sections and wherein the first and second side blocks are substantially the same height as the top and bottom sections.
